(19) United States
(12) Patent Application Publication
(10) Pub. No.: US 2023/0384101 A1
(43) Pub. Date: Nov. 30, 2023

(54) OFF-BEAT LOCATION RECOMMENDATIONS

(71) Applicant: FORD GLOBAL TECHNOLOGIES, LLC, Dearborn, MI (US)

(72) Inventors: Himanshu VERMA, Farmington Hills, MI (US); Fling TSENG, Ann Arbor, MI (US)

(21) Appl. No.: 17/828,712

(22) Filed: May 31, 2022

(51) Int. Cl. G01C 21/28; G01C 21/00; G06F 16/29

(52) U.S. Cl. CPC G01C 21/28; G01C 21/3811; G06F 16/29

(57) ABSTRACT

Recommendation of off-beat locations as destinations for vehicles is provided. Off-beat locations for a location of a vehicle are identified by a server. Each off-beat location is associated with a corresponding popularity score, the popularity score indicating a relative level of occupancy of the off-beat location. The off-beat locations are filtered by the server based on at least one threshold level of popularity score. The off-beat locations are recommended from the server to the vehicle as those that meet the at least one threshold level of popularity score.

### TECHNICAL FIELD

Aspects of the disclosure relate to identifying, recommending, and forgetting off-beat locations for use in suggestion destinations.

### BACKGROUND

Users may look for off-beat or less traveled natural locations for various reasons. However, users tend to have hard time finding out these locations. Navigation systems allow users to route to different locations. However, these systems are unhelpful when the user is not sure where to go.

### SUMMARY

In one or more illustrative examples, a system for recommendation of off-beat locations as destinations for vehicles is provided. A server includes a hardware processor configured to execute a location analysis service to perform operations including to identify off-beat locations for a location of a vehicle, each off-beat location being associated with a corresponding popularity score, the popularity score indicating a relative level of occupancy of the off-beat location; filter the off-beat locations based on at least one threshold level of popularity score; and recommend the off-beat locations to the vehicle that meet the at least one threshold level of popularity score.

In one or more illustrative examples, a method for recommendation of off-beat locations as destinations for vehicles is provided. Off-beat locations for a location of a vehicle are identified by a server. Each off-beat location is associated with a corresponding popularity score, the popularity score indicating a relative level of occupancy of the off-beat location. The off-beat locations are filtered by the server based on at least one threshold level of popularity score. The off-beat locations are recommended from the server to the vehicle as those that meet the at least one threshold level of popularity score.

In one or more illustrative examples, a non-transitory computer-readable medium includes instructions for recommendation of off-beat locations as destinations for vehicles that, when executed by an analysis server, cause the analysis server to perform operations including to identify off-beat locations for a location of a vehicle, each off-beat location being associated with a corresponding popularity score, the popularity score indicating a relative level of occupancy of the off-beat location; filter the off-beat locations based on at least one threshold level of popularity score; and recommend the off-beat locations to the vehicle that meet the at least one threshold level of popularity score.

### BRIEF DESCRIPTION OF THE DRAWINGS

FIG. 1 illustrates an example system for the recommendation of off-beat locations as destinations for vehicles;

FIG. 2 illustrates an example process for identifying off-beat locations;

FIG. 3 illustrates an example process for generating off-beat location recommendations for a user;

FIG. 4 illustrates an example process for providing off-beat location recommendations to a user;

FIG. 5 illustrates an example of the vehicle displaying an off-beat location settings user interface for configuration of the off-beat location functionality;

FIG. 6 illustrates an example of the vehicle displaying a user interface including an off-beat location alert;

FIG. 7 illustrates an example computing device for performing vehicle analytics using connected data captured from potential vehicle customers.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Users may look for off-beat or less-traveled natural locations for various reasons. However, with increasing number of people looking for such locations, users tend to have hard time finding out these locations on their own.

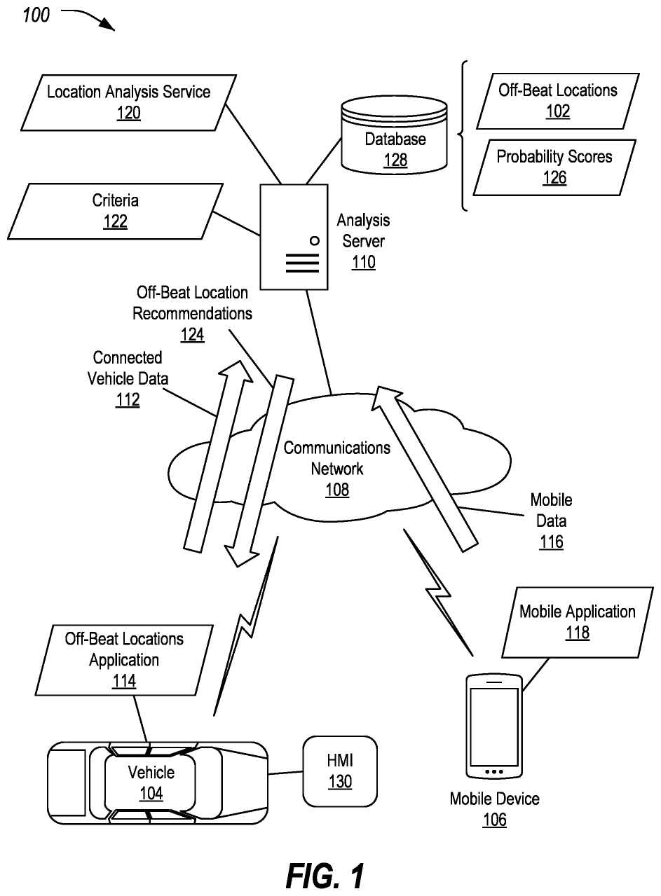

FIG. 1 illustrates an example system 100 for the recommendation of off-beat locations 102 as destinations for vehicles 104. Off-beat locations 102 may refer to location that are not crowded and/or where there are just few people around. Such locations are not crowded; yet are also not completely empty. These locations may, in some cases, be far from cities, such as around mountains, rivers, at less popular areas or parts of a natural-oriented parks, etc.

The vehicles 104 of the system 100 may be configured to communicate over a communications network 108. An analysis server 110 may be configured to receive connected data 112 from the vehicles 104. The analysis server 110 may also be configured to receive mobile data 116 from mobile devices 106. The analysis server 110 may identify off-beat locations 102 using sources of information including the connected data 112 and/or the mobile data 116. The analysis server 110 may maintain a database 128 of the off-beat locations 102 and may assign popularity scores 126 to the off-beat locations 102 based on the relative level of occupancy of the respective off-beat locations 102. The analysis server 110 may also be configured to generate off-beat location recommendations 124 for the vehicles 104 based on the popularity scores 126. These off-beat location recommendations 124 may include suggestions of off-beat locations 102 to be traveled to as intermediate or final destinations along routes of the vehicles 104.

The vehicle 104 may include various types of automobile, crossover utility vehicle (CUV), sport utility vehicle (SUV), truck, recreational vehicle (RV), boat, plane or other mobile machine for transporting people or goods. In many cases, the vehicle 104 may be a battery electric vehicle (BEV) powered by a traction battery and one or more electric motors. As a further possibility, the vehicle 104 may be a hybrid electric vehicle powered by both an internal combustion engine, a traction battery, and one or more electric motors. Hybrid vehicles 104 may come in various forms, such as a series hybrid electric vehicle, a parallel hybrid electrical vehicle, or a parallel/series hybrid electric vehicle. As the type and configuration of vehicle 104 may vary, the capabilities of the vehicle 104 may correspondingly vary. As some possibilities, vehicles 104 may have different capabilities with respect to passenger capacity, towing ability and capacity, and storage volume. For title, inventory, and other purposes, vehicles 104 may be associated with unique identifiers, such as vehicle identification numbers (VINs), globally unique identifiers (GUIDs), customer or fleet accounts, etc.

The mobile device 106 may be any of various types of portable computing device, such as cellular phones, tablet computers, smart watches, laptop computers, portable music players, or other devices having processing and communications capabilities. The mobile device 106 may include one or more processors configured to execute computer instructions, and a storage medium on which the computer-executable instructions and/or data may be maintained.

The mobile device 106 may further include various wireless transceivers, such as a BLUETOOTH or BLUETOOTH Low Energy (BLE) transceiver, as well as a transceiver for communication over a communications network 108. The communications network 108 may include one or more interconnected communication networks such as the Internet, a cable television distribution network, a satellite link network, a local area network, and a telephone network, as some non-limiting examples.

The vehicles 104 may further include various computing services to support the communication of the vehicles 104 personnel with infrastructure and/or with the other vehicles 104 themselves. In some examples, the vehicles 104 may perform the communication under the control of a telematics control unit (TCU). The TCU may include network hardware configured to facilitate communication between the vehicle 104 and other devices of the system 100. For example, the TCU may include or otherwise access a cellular modem configured to facilitate communication with the communications network 108. In some examples, the vehicles 104 further may include wireless transceivers, such as a BLUETOOTH or BLE transceivers, as well as transceivers for communication with the mobile devices 106 in addition to or instead of communicating over the communications network 108 directly.

The analysis server 110 may be an example of a networked computing device that is accessible to the vehicles 104 and/or mobile devices 106 over the communications network 108. The analysis server 110 may be configured to receive various data from the elements of the system 100. In an example, the analysis server 110 may be configured to receive connected data 112 from the vehicles 104. For instance, the vehicle 104 may execute an off-beat locations application 114 to provide connected data 112 to the analysis server 110 with respect to use of the vehicle 104. In another example, the analysis server 110 may be configured to receive mobile data 116 from a mobile application 118 executed by the mobile devices 106.

The connected data 112 may include information indicative of the whereabouts and other aspects of the vehicles 104. The connected data 112 may include, for example, locations of the vehicles 104, ignition on/off times and locations for the vehicles 104, driving behavior of the vehicles 104, start points, paths, and/or end points for routes traversed by the vehicles 104, distance traveled by the vehicles 104, time spent in the vehicles 104, etc. The connected data 112 may also include information with respect to the vehicle 104, such as make, model, year, weight, type (e.g., SUV, CUV, sedan, truck, etc.), mileage, owner, fleet manager, unique identifier (e.g., VIN, GUID, etc.), etc.

The mobile data 116 may include information indicative of the whereabouts and other aspects of the mobile devices 106. The mobile data 116 may include, for example, locations of the mobile devices 106, start points, paths, and/or end points for routes traversed by the mobile devices 106, distance traveled by the mobile devices 106, etc. The mobile data 116 may also include information with respect to the mobile device 106, such as make, model, year, device identifier, user identifier, etc.

A location analysis service 120 may be an example of an application executed by the analysis server 110. As explained in further detail herein, the location analysis service 120 may be configured to receive the connected data 112 and/or the mobile data 116. The connected data 112 may be used to determine the off-beat locations 102 and, accordingly, for determining the off-beat location recommendations 124 for the vehicles 104. In one example, the location analysis service 120 may receive the connected data 112 from the vehicles 104 while the customer is searching for an off-beat location 102. In another example, the location analysis service 120 may determine off-beat location recommendations 124 across the connected data 112 and/or the mobile data 116 for many users, which may be useful in determining off-beat locations 102 that at least some but not an overwhelming quantity of users are visiting.

The location analysis service 120 may utilize various criteria 122 for determining the off-beat locations 102 to suggest to the vehicles 104. In an example, the criteria 122 may include one or more of a minimum threshold score that an off-beat location 102 should exceed to be recommended, a maximum popularity threshold score that an off-beat location 102 should be below to be recommended, a history of off-beat location recommendations 124 provided to the vehicles 104, etc. The analysis server 110 may use stop duration indicated by the connected data 112 and/or the mobile data 116 to re-enforce how off-beat or what crowd level is acceptable for a user.

The system 100 may track a popularity score 126 for each location to identify how many users are at the location. The popularity scores 126 may accordingly indicate a relative level of occupancy of the respective off-beat location 102. The analysis server 110 may recommend off-beat locations 102 are above the minimum threshold popularity score 126, and which are also below the maximum popularity threshold popularity score 126. This may keep the off-beat locations 102 from being recommended to everyone. Additionally, as these off-beat locations 102 should be fresh, the system 100 may avoid recommending the same off-beat location(s) 102 every time. The analysis server 110 may maintain the off-beat locations 102 and the popularity scores 126 corresponding to the off-beat locations 102 in a database 128.

The vehicle 104 may include a human machine interface (HMI) 130 configured to provide information to users of the vehicle 104 as well as to receive input from the users. In an example, the HMI 130 may include one or more display screens and/or touch screens within the vehicle 104 cabin. In another example, the HMI 130 may include audio functionality, such as one or more microphones to receive voice input and a text-to-speech (TTS) system to provide voice prompts and responses via speakers in the vehicle 104 cabin. The HMI 130 of the vehicle 104 may be used for tasks such as navigation mapping and routing. The HMI 130 may also be used to provide indications of the off-beat locations 102.

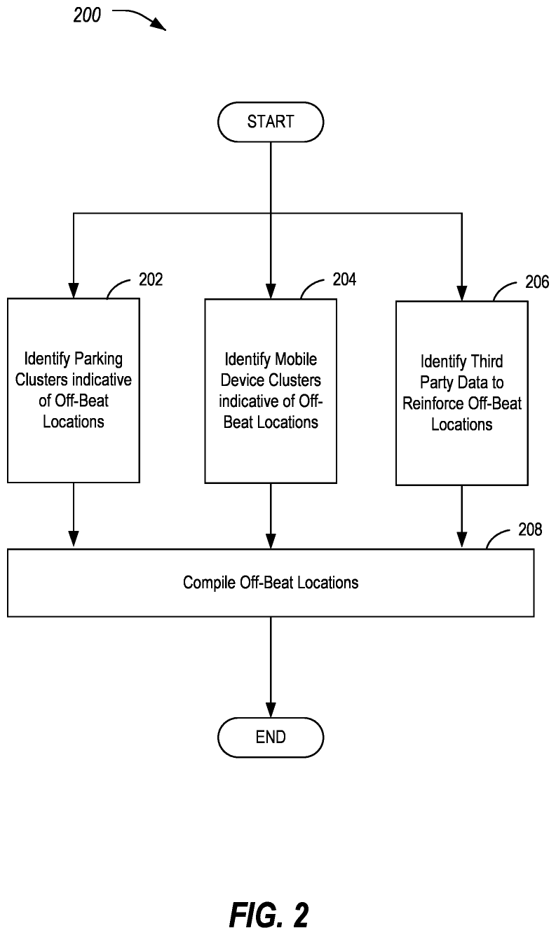

FIG. 2 illustrates an example process 200 for identifying off-beat locations 102. In an example, the process 200 may be performed by the analysis server 110 executing the location analysis service 120 in the context of the system 100. Various factors may be used alone or in combination for identifying the off-beat locations 102.

For instance, at operation 202, the analysis server 110 identifies parking clusters indicative of off-beat locations 102. In an example, the analysis server 110 may utilize a clustering algorithm on the locations indicated in the connected data 112 to identify parking clusters. For instance, to identify secluded off-beat locations 102, the analysis server 110 may identify parking clusters at least a predefined distance (e.g., one mile, five miles, ten miles, twenty miles, etc.) from main freeways, from arterial roadways, and/or within a predefined distance (e.g., one mile, five miles, ten miles, twenty miles, etc.) to natural areas such as parks, rivers, lakes, mountains, etc.

As another example, at operation 204, the analysis server 110 identifies mobile device 106 clusters indicative of off-beat locations 102. Similar to as done with the connected data 112, the analysis server 110 may utilize a clustering algorithm on the locations indicated in the mobile data 116 to identify device clusters. For instance, the analysis server 110 may utilize the mobile data 116 to identify trails or other non-roadway areas that may include clusters of mobile devices 106 (as opposed to vehicles 104).

As a further example, at operation 206, the analysis server 110 identifies third-party data to reinforce the off-beat locations 102. In an example, the analysis server 110 may retrieve publicly-available data (such as estimated or actual foot traffic data and/or location busy data) from GOOGLE maps or other third party data services.

At operation 208, the analysis server 110 compiles the off-beat locations 102. In an example, the analysis server 110 may identify a middle or other average location for the cluster of the off-beat locations 102. The analysis server 110 may then identify a label for the off-beat location 102 using map data including labels that correspond to geographic locations. For instance, the analysis server 110 may query one or more map databases to identify a name of a location that is closeted to the average location of the cluster of the off-beat location 102. The analysis server 110 may also update a maintained listing of the off-beat locations 102 determined at operations 202, 204 and 206 into the database 128 of off-beat locations 102. Moreover, if an off-beat location 102 no longer is popular enough to be located by the analysis server 110, then that off-beat location 102 may be removed from the database 128. Accordingly the analysis server 110 may forget off-beat locations 102 if they no longer appear to be desired. After operation 208, the process 200 ends.

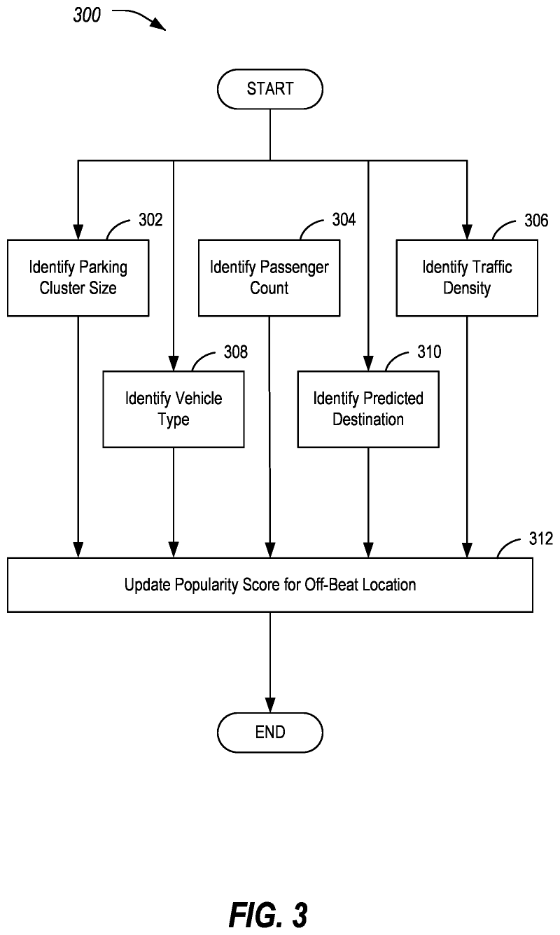

FIG. 3 illustrates an example process 300 for updating the popularity scores 126 for the off-beat locations 102 in the database 128. In an example, as with the process 200, the process 300 may be performed by the analysis server 110 executing the location analysis service 120 in the context of the system 100. The process 300 may be executed periodically by the location analysis service 120, such as on an hourly or daily basis. In another example the process 300 may be executed responsive to other trigger conditions, such as in response to a vehicle 104 requesting an off-beat location 102. The process 300 may be performed for all off-beat locations 102 in one example. In another example, the process 300 may be performed for off-beat locations 102 that are potential recommendations for a vehicle 104 (e.g., those off-beat locations 102 within a predefined distance (e.g., one mile, five miles, ten miles, twenty miles, etc.) to a vehicle 104 location or along a route of the vehicle 104).

At operation 302, the analysis server 110 identifies parking cluster size for the off-beat location 102. In an example, similar to as discussed at operation 202, the parking cluster size may be determined utilizing a clustering of the locations of the connected data 112. This clustering may be performed for the current time, for the most currently available connected data 112, and/or for connected data 112 received since the last periodic update of the popularity score 126. The more vehicles 104 in the cluster, the higher the popularity score 126.

At operation 304, the analysis server 110 identifies passenger count. In an example, the passenger count of the vehicles 104 at the clustered off-beat locations 102. For instance, the passenger count may be determined based on the connected data 112, for example based on the number of seat belts that are engaged, readings from seat weight sensors, etc. This counting of passengers may allow for a more accurate counting of the persons at the off-beat location 102 as compared to simply counting vehicles 104. The more passengers, the higher the popularity score 126.

At operation 306, the analysis server 110 identifies traffic density. In an example, vehicles 104 within a predefined radius (e.g., one mile, five miles, ten miles, twenty miles, etc.) to the off-beat location 102 may be counted, to allow for a further measure of the relative busy-ness of the off-beat location 102. The more vehicles 104 in proximity to the off-beat location 102, the higher the popularity score 126.

At operation 308, the analysis server 110 identifies vehicle type. In an example, the connected data 112 may indicate whether the vehicle 104 is a smaller vehicle 104 with a smaller passenger and/or cargo capacity or a larger vehicle 104 with a larger passenger and/or cargo capacity. The larger the vehicle 104, the higher the popularity score 126.

At operation 310, the analysis server 110 identifies a predicted destination of the user. In an example, the connected data 112 may include a destination for the vehicle 104. In another example, historical routes for the vehicle 104 based on historical connected data 112 for the vehicle 104 may be used to determine the predicted destination of the user. The driving distance and/or travel time of the vehicle 104 may be used to adjust whether to recommend an off-beat location 102. For instance, if the destination is greater than a threshold distance or time away, and/or the vehicle 104 has been in movement for at least a predefined distance (e.g., one mile, five miles, ten miles, twenty miles, etc.) or time (e.g., one minute, five minute, ten minute, twenty minute, one hour, two hours, five hours, etc.), then it may be more desirable to suggest off-beat locations 102.

At operation 312, the analysis server 110 utilizes the identified information to determine the popularity score 126. In an example, the analysis server 110 may utilize one or more of the elements of information determined at operations 302, 304, 206, 308, and 310 as inputs to an equation or model for determining the popularity score 126. The equation or model may weight the inputs to determine a single overall popularity score 126 for the off-beat location 102.

In many examples, the popularity score 126 may be scaled to a predefined scale (e.g., 0-100, 0 to 1, etc.) to allow for easier comparison of the popularity score 126 to the criteria 122. The scale may generally tun from a predefined minimum indicative of no occupancy, to a predefined maximum indicative of a upper threshold level of occupancy per cluster and/or per square area (e.g., 100 people, 1000 people, 1 person per square foot, etc.). By scaling the popularity score 126, the analysis server 110 may be able compare the popularity score 126 to a minimum threshold score that an off-beat location 102 should exceed to be recommended, and/or to a maximum popularity threshold score that an off-beat location 102 should be below to be recommended. After operation 312, the process 300 ends.

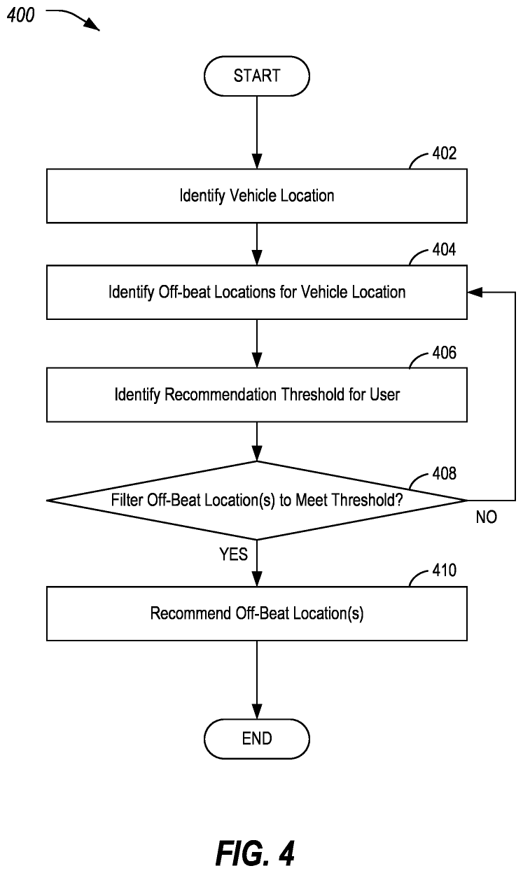

FIG. 4 illustrates an example process 400 for providing off-beat location recommendations 124 to a user. As with the processes 200 and 300, the process 400 may also be performed by the analysis server 110 executing the location analysis service 120 in the context of the system 100. In an example, the process 400 may be initiated responsive to the user affirmatively requesting the vehicle 104 for a suggested location, such as via the HMI 130 of the vehicle 104. In another example, the process 400 may be initiated periodically by the analysis server 110 or the vehicle 104 while the vehicle 104 is in a motive mode or in transit to a destination. In yet another example, the process 400 may be initiated at the outset of a vehicle 104 route.

At operation 402, the analysis server 110 identifies a location of the vehicle 104. In an example, the analysis server 110 may receive the location of the vehicle 104 in connected data 112 from the vehicle 104. In another example, the analysis server 110 may receive the location of the vehicle 104 from a mobile device 106 of an occupant of the vehicle 104. In yet another example, the analysis server 110 may receive the location of the vehicle 104 inferentially, such as based on the locations of communications network 108 infrastructure at the point of origin of connected data 112 received from the vehicle 104.

At operation 404, the analysis server 110 identifies off-beat locations 102 corresponding to the location of the vehicle 104. In an example, the analysis server 110 may access the database 128 to identify off-beat locations 102 within a predefined boundary (e.g., one mile, five miles, ten miles, twenty miles, etc.) from the location of the vehicle 104. The analysis server 110 may also retrieve the popularity scores 126 corresponding to the off-beat locations 102 from the database 128.

At operation 406, the analysis server 110 identifies a recommendation threshold for the user. In an example, the analysis server 110 may utilize a default minimum recommendation threshold for the user (e.g., 0.3 on a scale of 0.1 to 1.0). The default minimum threshold may serve to filter out popularity scores 126 for off-beat locations 102 that are not popular enough to be suggested to the user. In another example, the analysis server 110 may utilize a default maximum recommendation threshold for the user (e.g., 0.7 on a scale of 0.1 to 1.0). The default maximum threshold may serve to filter out popularity scores 126 for off-beat locations 102 that are too popular to be suggested to the user (e.g., that have become too popular and are no longer off-beat). In another example, both minimum and maximum thresholds may be identified for comparison to ensure that both the off-beat locations 102 is popular enough and also not too popular.

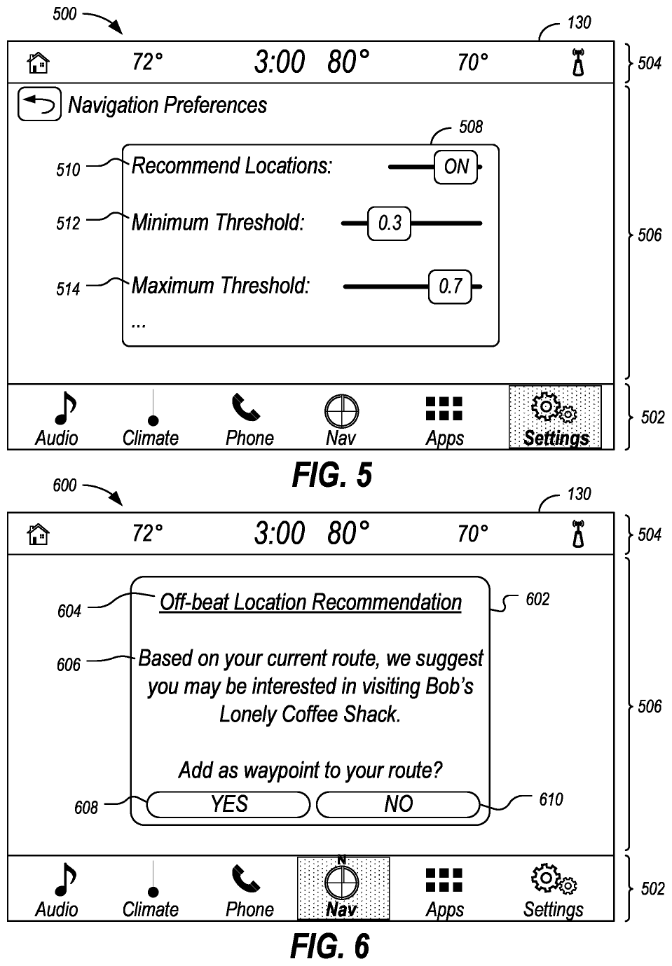

In some examples, the analysis server 110 may include criteria 122 customized to the specific user. The criteria 122 may be used to customize the minimum and/or maximum thresholds to the user and/or to other circumstances. In an example, these thresholds may be settable by the user using the HMI 130 allowing for selection of the user's tolerance or preference to accept different off-beat locations 102. For instance, a control may be provided to allow the user to choose a minimum level of popularity, and/or a second control may be provided to allow the user to choose a maximum level of popularity. An example HMI 130 for manipulating the settings is discussed below with respect to FIG. 5. In a variation, these controls may be selectable by the user for various use cases, such as for seeking recommended coffee shops vs. hiking trails vs. playgrounds for children, etc.

At operation 408, the analysis server 110 determines whether the popularity score 126 meets the recommendation threshold. In an example, the analysis server 110 may filter out the popularity scores 126 for off-beat locations 102 that fail to meet the one or more thresholds as identified at operation 406.

As a variation, the filtering at operation 408 may, in another aspects, may use the user's own connected data 112 and mobile data 116 to aid in confirming whether a user spent time at an off-beat location 102 or not. For instance, if the user's data indicates that the user has already visited the off-beat location 102, then that off-beat location 102 may be filtered out and not recommended again. Or, as another possibility, if the user's data indicates that the user has already been suggested the off-beat location 102 and chose not to visit, then that off-beat location 102 may be filtered out and not recommended again.

At operation 410, the analysis server 110 recommends the off-beat location 102. In an example, the analysis server 110 identifies the off-beat location 102 as being the off-beat location 102 having the highest popularity score 126 that is not filtered out at operation 408. In another example, the analysis server 110 identifies the off-beat location 102 as being the off-beat location 102 having the lowest popularity score 126 that is not filtered out at operation 408. In yet another example, the analysis server 110 identifies the off-beat location 102 as being the two, three, four, five, or other predefined number of off-beat location 102 having the highest (or lowest) popularity scores 126 that are not filtered out at operation 408. In still a further example, the analysis server 110 utilizes all the off-beat locations 102 that satisfy operation 408. Regardless of approach, the analysis server 110 sends the vehicle 104 an off-beat location recommendation 124 including the one or more off-beat locations 102. The off-beat location 102 may be suggested to the user via the HMI 130. An example of such a recommendation is discussed below with respect to FIG. 6. After operation 410, the process 400 ends.

FIG. 5 illustrates an example of the vehicle 104 displaying an off-beat location settings user interface 500 for configuration of the off-beat location 102 functionality. In an example, the user interface 500 may be displayed on a head unit or other HMI 130 of the vehicle 104.

As shown, the user interface 500 includes a category listing 502 of one or more screens of content to be displayed in the main screen area 506 of the HMI 130. As some examples, the category listing 502 may include an audio screen from which configuration of vehicle 104 audio settings may be performed, a climate control screen from which vehicle 104 climate control settings may be configured, a phone screen from which calling services may be utilized, a navigation screen from which maps and routing may be performed, an applications screen from which installed applications may be invoked, and a settings screen from which backlighting or other general settings of the HMI 130 may be accessed. The user interface 500 may also include a general information area 504 from which time, current temperature, and other information may remain visible to the user, regardless of the specific screen or application that is active in the main screen area 506.

The main screen area 506 may show summary content from multiple of the categories of content. In an example, the main screen area 506 may display an audio summary indicating a reduced version of the content displayed when the audio settings are selected, and a phone summary indicating a reduced version of the content displayed when the phone settings are selected.

The user interface 500 may be displayed, for example, responsive to user selection of the navigation settings from a settings screen displayed upon selection of the settings screen from the category listing 502. As shown, the user interface 500 provides a set of configurable options 508 displayed to the main screen area 506 that may be used by a user to adjust the criteria 122 and/or other settings of the off-beat locations 102 functionality. As shown, the configurable options 508 may include a recommend locations toggle setting 510, a minimum threshold sensitivity setting 512, and a maximum threshold sensitivity setting 514.

The recommend locations toggle setting 510 may allow the user to choose whether or not to receive recommendations of off-beat locations 102. This may allow the user to decide whether or not to receive off-beat location recommendations 124 of off-beat locations 102 in the HMI 130. When deselected, the vehicle 104 may also refrain from sending the connected data 112, which may reduce the vehicle 104 data load on the communications network 108. When selected, the vehicle 104 may send the connected data 112 and be allowed to receive off-beat location recommendations 124.

The minimum threshold sensitivity setting 512 may allow the user to select a minimum threshold level of popularity scores 126 for the off-beat locations 102 that are recommended to the user. This setting may be increased to cause the vehicle 104 to filter out off-beat locations 102 having lower popularity scores 126, and may be decreased to cause the vehicle 104 to allow for the recommendation of off-beat locations 102 having lower popularity scores 126. In some examples, the filtering of off-beat locations 102 may be performed by the location analysis service 120, in which case the user's minimum threshold sensitivity setting 512 may be sent by the vehicle 104 to the analysis server 110. In other examples, the filtering of off-beat locations 102 may be performed by the vehicle 104 on the received off-beat location recommendations 124, and in some cases the minimum threshold sensitivity setting 512 may be maintained local to the vehicle 104 and not provided to the analysis server 110.

The maximum threshold sensitivity setting 514 may allow the user to select a maximum threshold level of popularity scores 126 for the off-beat locations 102 that are recommended to the user. This setting may be increased to cause the vehicle 104 to allow off-beat locations 102 having high popularity scores 126, and may be decreased to cause the vehicle 104 to filter out the recommendation of off-beat locations 102 having popularity scores 126 that are too high. As with the minimum threshold sensitivity setting 512, in some examples, the filtering of off-beat locations 102 may be performed by the location analysis service 120, in which case the user's maximum threshold sensitivity setting 514 may be sent by the vehicle 104 to the analysis server 110. In other examples, the filtering of off-beat locations 102 may be performed by the vehicle 104 on the received off-beat location recommendations 124, and in some cases the maximum threshold sensitivity setting 514 may be maintained local to the vehicle 104 and not provided to the analysis server 110.

FIG. 6 illustrates an example of the vehicle 104 displaying a user interface 600 including an off-beat location alert 602. In an example, the user interface 600 may be displayed on a head unit or other HMI 130 of the vehicle 104. The off-beat location alert 602 may be displayed responsive to the vehicle 104 receiving an off-beat location recommendation 124. The off-beat location alert 602 may indicate, as shown, that an off-beat location 102 is being recommended to the user for navigation.

As shown, the off-beat location alert 602 includes a title 604 indicating that the off-beat location alert 602 is related to off-beat location recommendations 124, and a message 606 indicating information about the off-beat location 102 being recommended in the off-beat location recommendation 124. The off-beat location alert 602 may further include an affirmation control 608 that, when selected by the user, causes the vehicle 104 to add the off-beat location 102 to the navigated route. The off-beat location alert 602 may also include a dismiss control 610 that, when selected by the user, causes the vehicle 104 to ignore the off-beat location 102 and not additionally route to it. Thus, by using the off-beat location alert 602, the user may be able to automatically receive and navigate to off-beat locations 102 that the user may not otherwise be aware of.

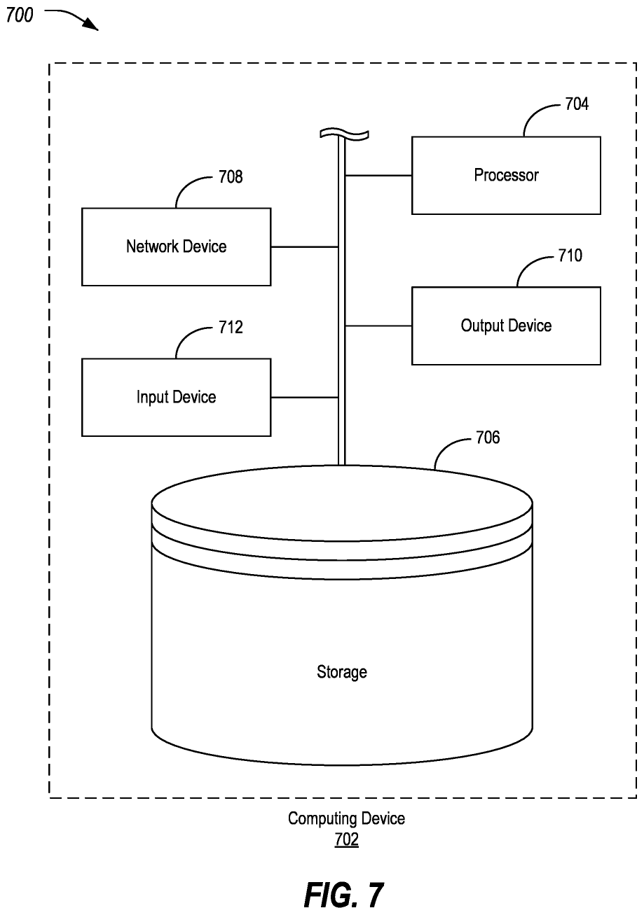

FIG. 7 illustrates an example computing device 702 for performing vehicle 104 analytics using connected data 112 captured from potential vehicle 104 customers. Referring to FIG. 7, and with reference to FIGS. 1-6, the vehicles 104, mobile devices 106, communications network 108, and analysis servers 110 may include examples of such computing devices 702. Computing devices 702 generally include computer-executable instructions, such as those of the location analysis service 120 and the off-beat locations application 114, where the instructions may be executable by one or more computing devices 702. Computer-executable instructions may be compiled or interpreted from computer programs created using a variety of programming languages and/or technologies, including, without limitation, and either alone or in combination, Java™, C, C++, C #, Visual Basic, JavaScript, Python, JavaScript, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data, such as connected data 112, mobile data 116, off-beat locations 102, and off-beat location recommendations 124, may be stored and transmitted using a variety of computer-readable media.

As shown, the computing device 702 may include a processor 704 that is operatively connected to a storage 706, a network device 708, an output device 710, and an input device 712. It should be noted that this is merely an example, and computing devices 702 with more, fewer, or different components may be used.

The processor 704 may include one or more integrated circuits that implement the functionality of a central processing unit (CPU) and/or graphics processing unit (GPU). In some examples, the processors 704 are a system on a chip (SoC) that integrates the functionality of the CPU and GPU. The SoC may optionally include other components such as, for example, the storage 706 and the network device 708 into a single integrated device. In other examples, the CPU and GPU are connected to each other via a peripheral connection device such as Peripheral Component Interconnect (PCI) express or another suitable peripheral data connection. In one example, the CPU is a commercially available central processing device that implements an instruction set such as one of the x86, ARM, Power, or Microprocessor without Interlocked Pipeline Stages (MIPS) instruction set families.

Regardless of the specifics, during operation the processor 704 executes stored program instructions that are retrieved from the storage 706. The stored program instructions, accordingly, include software that controls the operation of the processors 704 to perform the operations described herein. The storage 706 may include both non-volatile memory and volatile memory devices. The non-volatile memory includes solid-state memories, such as Not AND (NAND) flash memory, magnetic and optical storage media, or any other suitable data storage device that retains data when the system is deactivated or loses electrical power. The volatile memory includes static and dynamic random access memory (RAM) that stores program instructions and data during operation of the system 100.

The GPU may include hardware and software for display of at least two-dimensional (2D) and optionally three-dimensional (3D) graphics to the output device 710. The output device 710 may include a graphical or visual display device, such as an electronic display screen, projector, printer, or any other suitable device that reproduces a graphical display. As another example, the output device 710 may include an audio device, such as a loudspeaker or headphone. As yet a further example, the output device 710 may include a tactile device, such as a mechanically raiseable device that may, in an example, be configured to display braille or another physical output that may be touched to provide information to a user.

The input device 712 may include any of various devices that enable the computing device 702 to receive control input from users. Examples of suitable input devices 712 that receive human interface inputs may include keyboards, mice, trackballs, touchscreens, microphones, graphics tablets, and the like.

The network devices 708 may each include any of various devices that enable the described components to send and/or receive data from external devices over networks. Examples of suitable network devices 708 include an Ethernet interface, a Wi-Fi transceiver, a cellular transceiver, or a BLUETOOTH or BLE transceiver, or other network adapter or peripheral interconnection device that receives data from another computer or external data storage device, which can be useful for receiving large sets of data in an efficient manner.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A system for recommendation of off-beat locations as destinations for vehicles, comprising:
a server including a hardware processor configured to execute a location analysis service to perform operations including to:
identify off-beat locations for a location of a vehicle, each off-beat location being associated with a corresponding popularity score, the popularity score indicating a relative level of occupancy of the off-beat location;
filter the off-beat locations based on at least one threshold level of popularity score; and
recommend the off-beat locations to the vehicle that meet the at least one threshold level of popularity score.

2. The system of claim 1, wherein the off-beat locations are identified as being within a predefined distance from the location of the vehicle.

3. The system of claim 1, wherein the location of the vehicle is determined based on one or more of:
location data indicated in connected data received to the server from the vehicle;
location data received to the server from a mobile device of an occupant of the vehicle; or
inference based on a location of communications network infrastructure at a point of origin of the connected data sent by the vehicle to the server.

4. The system of claim 1, wherein the server is further programmed to execute the location analysis service to perform operations including to:
identify clusters of parked vehicles,
determine an average location of each of the clusters; and
utilize a database of locations to names to associate each of the clusters with a name that corresponds to the average location.

5. The system of claim 4, wherein the server is further programmed to execute the location analysis service to perform operations including to:
identify a passenger count of each of the parked vehicles of the clusters; and
update the corresponding popularity score to value each vehicle according to the passenger count of occupants in determining the relative level of occupancy.

6. The system of claim 4, wherein the server is further programmed to execute the location analysis service to perform operations including to scale the popularity score along a relative scale from a predefined minimum indicative of no occupancy, to a predefined maximum indicative of a upper threshold level of occupancy.

7. The system of claim 1, wherein the server is further programmed to execute the location analysis service to perform operations including to refrain from recommending one of the off-beat locations more than once to the vehicle.

8. The system of claim 1, wherein the at least one threshold level of popularity score includes:
a minimum threshold sensitivity setting below which the off-beat locations are filtered out as been too unoccupied; and
a maximum threshold sensitivity setting above which the off-beat locations are filtered out as been too occupied.

9. A method for recommendation of off-beat locations as destinations for vehicles, comprising:
identifying, by a server, off-beat locations for a location of a vehicle, each off-beat location being associated with a corresponding popularity score, the popularity score indicating a relative level of occupancy of the off-beat location;
filtering the off-beat locations by the server based on at least one threshold level of popularity score; and
recommending the off-beat locations, from the server to the vehicle, meeting the at least one threshold level of popularity score.

10. The method of claim 9, wherein the off-beat locations are identified as being within a predefined distance from the location of the vehicle.

11. The method of claim 9, wherein the location of the vehicle is determined based on one or more of:
location data indicated in connected data received to the server from the vehicle;
location data received to the server from a mobile device of an occupant of the vehicle; or
inference based on a location of communications network infrastructure at a point of origin of the connected data sent by the vehicle to the server.

12. The method of claim 9, further comprising:
identifying clusters of parked vehicles,
determining an average location of each of the clusters; and
utilizing a database of locations to names to associate each of the clusters with a name that corresponds to the average location.

13. The method of claim 12, further comprising:
identifying a passenger count of each of the parked vehicles of the clusters; and
updating the corresponding popularity score to value each vehicle according to the passenger count of occupants in determining the relative level of occupancy.

14. The method of claim 12, further comprising scaling the popularity score along a relative scale from a predefined minimum indicative of no occupancy, to a predefined maximum indicative of a upper threshold level of occupancy.

15. The method of claim 9, further comprising refraining from recommending one of the off-beat locations more than once to the vehicle.

16. A non-transitory computer-readable medium comprising instructions for recommendation of off-beat locations as destinations for vehicles that, when executed by an analysis server, cause the analysis server to perform operations including to:
identify off-beat locations for a location of a vehicle, each off-beat location being associated with a corresponding popularity score, the popularity score indicating a relative level of occupancy of the off-beat location;
filter the off-beat locations based on at least one threshold level of popularity score; and
recommend the off-beat locations to the vehicle that meet the at least one threshold level of popularity score.

17. The medium of claim 16, further comprising instructions vehicles that, when executed by the analysis server, cause the analysis server to perform operations including to:
identify clusters of parked vehicles,
determine an average location of each of the clusters; and
utilize a database of locations to names to associate each of the clusters with a name that corresponds to the average location.

18. The medium of claim 17, further comprising instructions vehicles that, when executed by the analysis server, cause the analysis server to perform operations including to:
identify a passenger count of each of the parked vehicles of the clusters; and
update the corresponding popularity score to value each vehicle according to the passenger count of occupants in determining the relative level of occupancy.

19. The medium of claim 17, further comprising instructions vehicles that, when executed by the analysis server, cause the analysis server to perform operations including to scale the popularity score along a relative scale from a predefined minimum indicative of no occupancy, to a predefined maximum indicative of a upper threshold level of occupancy.

20. The medium of claim 16, further comprising instructions vehicles that, when executed by the analysis server, cause the analysis server to perform operations including to refrain from recommending one of the off-beat locations more than once to the vehicle.
